(19) United States
(12) Patent Application Publication
(10) Pub. No.: US 2026/0257807 A1
(43) Pub. Date: Sep. 3, 2026

(54) SHIM LAYER WITH SEAL GROOVE

(71) Applicant: The Boeing Company, Arlington, VA (US)

(72) Inventors: Michael Dean Rozema, St. Peters, MO (US); Steven Arthur Kaprielian, Saint Charles, MO (US); Sharon Sofian, St. Peters, MO (US); David John Sundquist, O'Fallon, MO (US); Andrew C. Schubert, Wildwood, MO (US); Loren Jacob Strahm, Glen Carbon, IL (US)

(21) Appl. No.: 19/067,432

(22) Filed: Feb. 28, 2025

(51) Int. Cl. B64D 37/06; B64C 1/12

(52) U.S. Cl. CPC B64D 37/06; B64C 1/12

(57) ABSTRACT

Shim layers with a seal groove are disclosed. An example fuel containment apparatus constructed with the teachings herein includes a skin defining an outer surface of the apparatus, a substructure to which the skin is coupled, a shim between the skin and the substructure wherein the shim includes a groove, and a sealant located within the groove.

### FIELD OF THE DISCLOSURE

This disclosure relates generally to seal grooves and, more particularly, to seal grooves in a shim layer.

### BACKGROUND

Seal grooves are used in a wide range of applications. Seal grooves are commonly used in the aerospace industry to seal joints and faying surfaces in aircraft structures. Existing solutions require supporting a seal groove on either side with metal, which is of significant weight. Reducing this weight is important when improving performance of the aircraft.

### BRIEF DESCRIPTION OF THE DRAWINGS

FIG. 1A is a plan view of an example fuel containment system including a shim with a groove constructed in accordance with the teachings herein.

FIG. 1B is a cross-sectional view of a seal assembly taken along section line A-A of the fuel containment system of FIG. 1A.

FIG. 2 is a view of an example aircraft with an integrated fuel tank constructed in accordance with the teachings herein.

FIG. 3A is a partial view of the example aircraft of FIG. 2.

FIG. 3B is a cross-sectional view of a seal assembly of FIG. 3A.

FIG. 4 is a flowchart of a method for forming a fuel container in accordance with the teachings herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### SUMMARY

An example fuel containment apparatus includes a skin defining an outer surface of the apparatus, a substructure to which the skin is coupled, a shim between the skin and the substructure, wherein the shim includes a groove, and a sealant located within the groove.

An example aircraft includes a composite skin, a substructure, a shim layer located between the composite skin and the substructure, a plurality of integrated fuel tanks defined in part by the composite skin and the substructure, a plurality of grooves located within the shim layer around a boundary of the plurality of integrated fuel tanks, and a sealant located within the groove.

An example method for forming a fuel container includes coupling a shim to a skin defining an outer surface of the fuel container, machining a groove in the shim, applying a sealant within the groove, and coupling the shim and the composite skin to a substructure so that the sealant forms a seal between the skin and the substructure.

### DETAILED DESCRIPTION

Traditionally, groove sealing is accomplished by machining a groove into either the composite skin or the substructure of an aircraft and then injecting a non-curing sealant into the groove, which then seals one faying surface to another. The composite skin and substructures are both structural components of the aircraft. When machining the seal groove into such structural components, the structure must be reinforced. This reinforcement is typically accomplished by adding metal material to either side of the groove. Adding this material effectively reinforces the groove but adds significant weight.

In certain applications, for example military applications, reducing the weight of and improving reliability of an aircraft is particularly desirable. The examples disclosed herein allow for significant weight reduction while improving the reliability of the traditional seal groove. Recent manufacturing advancements have created a sacrificial, non-structural shim on the inner mold line of the composite skins that is machined to fit the substructure. This non-structural shim is machined flat to conform to the substructure and correct any unevenness of the composite skin. The examples disclosed herein provide for increasing the thickness of the shim and machining the seal groove into the shim, which does not compromise the strength of the overall structure. Adding material to the non-structural shim allows for significant weight savings because the shim can be made from a lightweight material such as fiberglass as compared to the reinforcement needed with traditional seal grooves. Further, machining the groove into the shim allows for the movement of any crack initiation points and fatigue sensitive features into a non-structural member (i.e., the shim). As a result, any cracks that do initiate because of the seal groove feature are contained in the non-structural member, which would not be detrimental to the lifetime or performance of an aircraft.

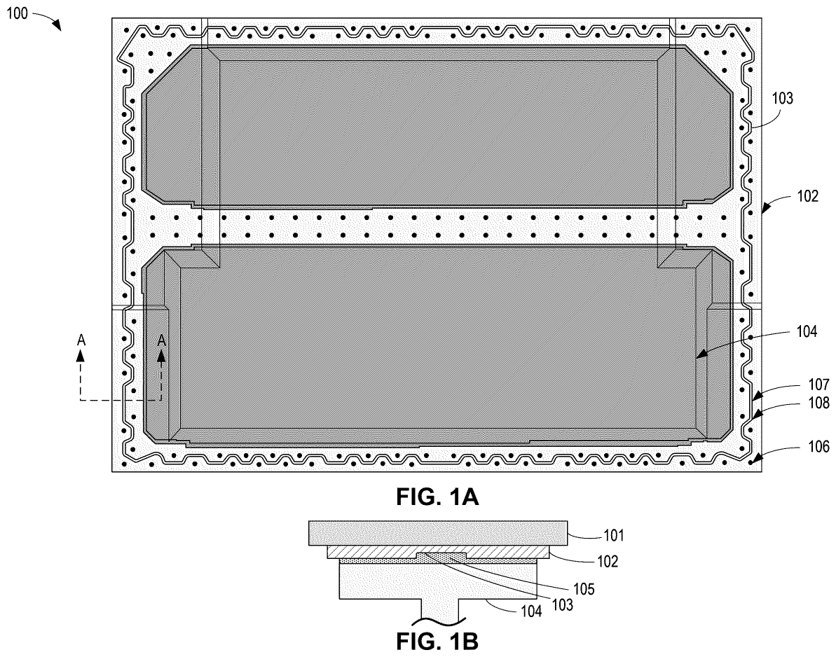

FIG. 1A is a plan view of an example fuel containment apparatus 100, and FIG. 1B is a cross-sectional view of a seal assembly taken along section line A-A of the fuel containment apparatus 100 of FIG. 1A. Referring to FIGS. 1A and 1B, a skin 101 defines an outer surface of the apparatus 100, the skin 101 is coupled to a metal substructure 104, a shim 102 is disposed between the skin 101 and the metal substructure 104, wherein the shim 102 includes a groove 103, and a sealant 105 is located within the groove 103. The skin 101 in FIG. 1A is shown as transparent to show the underlying structure. The shim 102 of the illustrated example fuel containment apparatus 100 includes a fiberglass material. However, in some examples the shim 102 may include other materials such as carbon fiber. In the illustrated example, the skin 101 is fastened to the metal substructure 104 by a plurality of mechanical fasteners 106, and the groove 103 follows a serpentine pattern between the fasteners. The serpentine pattern of the groove 103 includes generally flat or straight sections 107 joined by arced or curved sections 108, wherein the curved sections 108 are minimized to allow for easier inspection during manufacturing. In some examples, the groove 103 may follow a non-serpentine pattern (e.g. a straight line). In the illustrated example, the shim 102 is a machined flat surface to adhere to a 0.060 inch profile tolerance. In the illustrated example, the sealant 105 used is a curing sealant, however in other examples the sealant 105 may be of a non-curing type. The substructure in the illustrated example is made of metal. However, in other examples the substructure may include composite materials (e.g., carbon fiber, fiberglass, etc.).

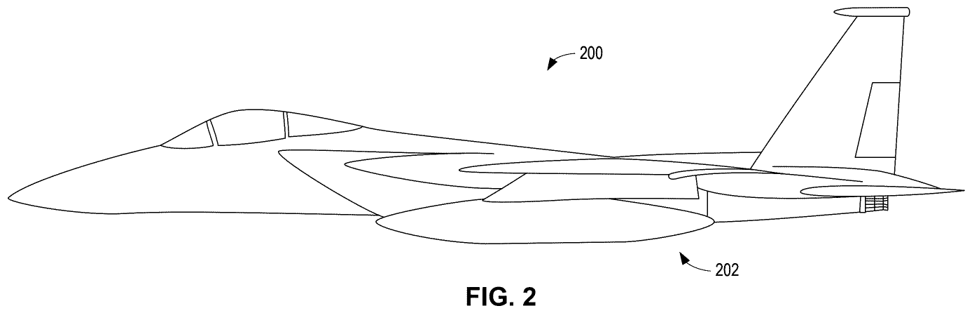

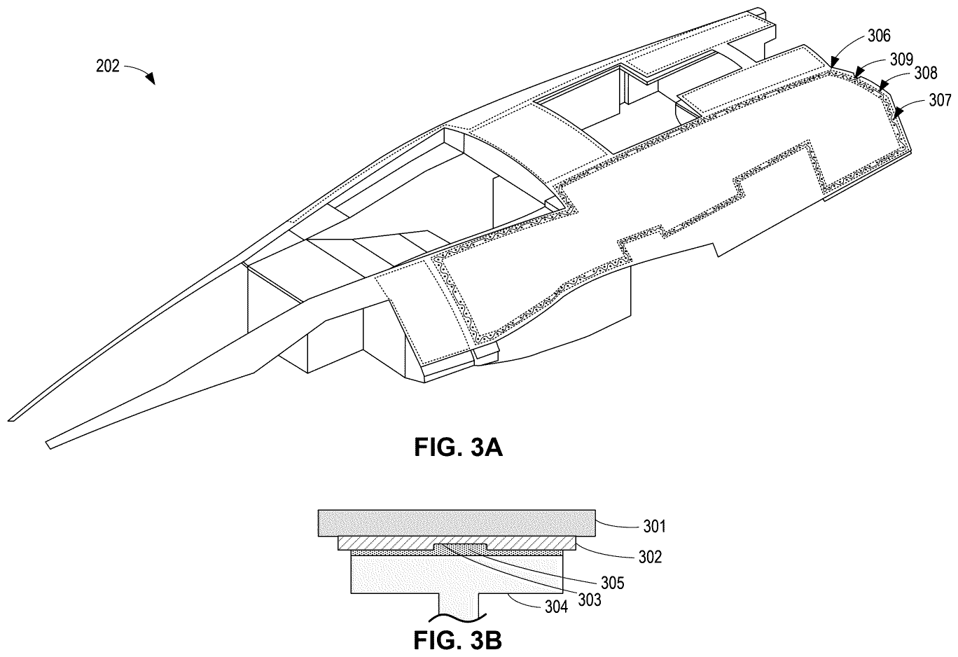

FIG. 2 in connection with FIGS. 3A-3B depicts an example aircraft 200 constructed in accordance with the teachings herein. FIG. 3A provides a detailed view of an underside 202 of the aircraft 200 of FIG. 2. The aircraft 200 of the illustrated example includes a skin 301, a metal substructure 304, a shim layer 302 located between the skin 301 and the metal substructure 304, a plurality of grooves 303 located within the shim layer 302 around a boundary of the plurality of integrated fuel tanks 306, and a sealant 305 located within the grooves 303. The shim layer 302 of the illustrated aircraft includes a fiberglass material. However, in some examples the shim layer 302 may include other materials such as carbon fiber. In the illustrated example, the skin 301 is fastened to the metal substructure 304 by a plurality of mechanical fasteners 307, and the grooves 303 follow a serpentine pattern between the fasteners. The serpentine pattern of the grooves 303 includes generally flat or straight sections 308 joined by arced or curved sections 309, wherein the curved sections 309 are minimized to allow for easier inspection during manufacturing. In some examples, the grooves 303 may follow a non-serpentine pattern (e.g. a straight line). In the illustrated example, the shim 302 layer is a machined flat surface to adhere to a 0.060 inch profile tolerance. In the illustrated example the sealant 305 is a curing sealant, however in other examples the sealant 305 may be of a non-curing type. The substructure in the illustrated example is made of metal. However, in other examples the substructure may include composite materials (e.g., carbon fiber, fiberglass, etc.).

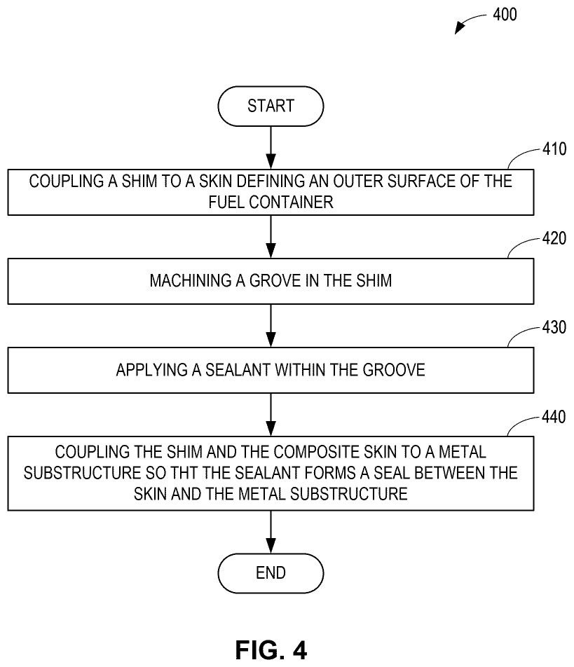

FIG. 4 is an example flowchart of a method for forming a fuel container including coupling a shim to a skin defining an outer surface of the fuel container 410, machining a groove in the shim 420, applying a sealant within the groove 430, and coupling the shim and the composite skin to a metal substructure so that the sealant forms a seal between the skin and the metal substructure 440. The shim of the illustrated method includes a fiberglass material. However, in some examples the shim may include other materials such as carbon fiber. In some examples, the skin is fastened to the metal substructure by a plurality of mechanical fasteners, and the groove is machined in a serpentine pattern between the fasteners. The serpentine pattern of the groove includes generally flat or straight sections as compared to arced or curved sections to allow for easier inspection during manufacturing. In the illustrated example, the shim is a machined flat surface. In the illustrated example, the sealant used is a curing sealant, however in other examples the sealant may be of a non-curing type. The substructure in the illustrated example is made of metal. However, in other examples the substructure may include composite materials (e.g., carbon fiber, fiberglass, etc.).

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed that allow for a shim layer with a seal groove. Disclosed systems, apparatus, articles of manufacture, and methods are accordingly directed to one or more improvement(s) of a seal groove for use in an application such as an aircraft.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

Example 1 includes a fuel containment apparatus including a skin defining an outer surface of the apparatus, a substructure to which the skin is coupled, a shim between the skin and the substructure, wherein the shim includes a groove, and a sealant located within the groove.

Example 2 includes the fuel containment apparatus of example 1, wherein the shim includes a fiberglass material.

Example 3 includes the apparatus of example 1, wherein the skin is fastened to the substructure by a plurality of mechanical fasteners, and the groove follows a serpentine pattern between the fasteners.

Example 4 includes the apparatus of example 3, wherein the serpentine pattern includes non-curved sections.

Example 5 includes the fuel containment apparatus of example 1, wherein the shim has a machined flat surface.

Example 6 includes the fuel containment apparatus of example 1, wherein the sealant is a curing sealant.

Example 7 includes an aircraft including a skin, a substructure, a shim layer located between the composite skin and the substructure, a plurality of integrated fuel tanks defined in part by the skin and the substructure, a plurality of grooves located within the shim layer around a boundary of the plurality of integrated fuel tanks, and a sealant located within the groove.

Example 8 includes the aircraft of example 7, wherein the shim layer includes a fiberglass material.

Example 9 includes the aircraft of example 7, wherein the skin is fastened to the substructure with a plurality of mechanical fasteners, and the plurality of grooves forms a serpentine pattern between the fasteners.

Example 10 includes the aircraft of example 9, wherein the serpentine pattern includes non-curved sections.

Example 11 includes the aircraft of example 7, wherein the shim layer includes a machined flat surface.

Example 12 includes the aircraft of example 7, wherein the sealant is a curing sealant.

Example 13 includes a method for forming a fuel container including coupling a shim to a skin defining an outer surface of the fuel container, machining a groove in the shim, applying a sealant within the groove, and coupling the shim and the skin to a substructure so that the sealant forms a seal between the skin and the substructure.

Example 14 includes the method of example 13, wherein the shim includes a fiberglass material.

Example 15 includes the method of example 13, wherein coupling the shim and the skin to the substructure includes fastening the skin and shim to the substructure using a plurality of mechanical fasteners.

Example 16 includes the method of example 15, wherein machining the groove in the shim includes machining the groove to form a serpentine pattern between the plurality of mechanical fasteners.

Example 17 includes the method of example 16, wherein the serpentine pattern includes non-curved sections.

Example 18 includes the method of example 13, further including machining the shim to be flat.

Example 19 includes the method of example 13, wherein the sealant is a curing sealant.

Example 20 includes the method of example 13, wherein the shim is non-load carrying.

What is claimed is:

1. A fuel containment apparatus comprising:
a skin defining an outer surface of the apparatus;
a substructure to which the skin is coupled;
a shim between the skin and the substructure wherein the shim includes a groove; and
a sealant located within the groove.

2. The fuel containment apparatus of claim 1, wherein the shim includes a fiberglass material.

3. The fuel containment apparatus of claim 1, wherein the skin is fastened to the substructure by a plurality of mechanical fasteners, and the groove follows a serpentine pattern between the fasteners.

4. The fuel containment apparatus of claim 3, wherein the serpentine pattern includes non-curved sections.

5. The fuel containment apparatus of claim 1, wherein the shim has a machined flat surface.

6. The fuel containment apparatus of claim 1, wherein the sealant is a curing sealant.

7. An aircraft comprising:
a skin;
a substructure;
a shim layer located between the composite skin and the substructure;
a plurality of integrated fuel tanks defined in part by the skin and the substructure;
a plurality of grooves located within the shim layer around a boundary of the plurality of integrated fuel tanks; and
a sealant located within the groove.

8. The aircraft of claim 7, wherein the shim layer includes a fiberglass material.

9. The aircraft of claim 7, wherein the skin is fastened to the substructure with a plurality of mechanical fasteners, and the plurality of grooves forms a serpentine pattern between the fasteners.

10. The aircraft of claim 9, wherein the serpentine pattern includes non-curved sections.

11. The aircraft of claim 7, wherein the shim layer includes a machined flat surface.

12. The aircraft of claim 7, wherein the sealant is a curing sealant.

13. A method for forming a fuel container comprising:
coupling a shim to a skin defining an outer surface of the fuel container;
machining a groove in the shim;
applying a sealant within the groove; and
coupling the shim and the skin to a substructure so that the sealant forms a seal between the skin and the substructure.

14. The method of claim 13, wherein the shim includes a fiberglass material.

15. The method of claim 13, wherein coupling the shim and the skin to the substructure includes fastening the shim and skin to the substructure using a plurality of mechanical fasteners.

16. The method of claim 15, wherein machining the groove in the shim includes machining the groove to form a serpentine pattern between the plurality of mechanical fasteners.

17. The method of claim 16, wherein the serpentine pattern includes non-curved sections.

18. The method of claim 13, further including machining the shim to be flat.

19. The method of claim 13, wherein the sealant is a curing sealant.

20. The method of claim 13, wherein the shim is non-load carrying.
